(19) United States
(12) Patent Application Publication
(10) Pub. No.: US 2013/0211968 A1
(43) Pub. Date: Aug. 15, 2013

(54) E-Commerce Systems and Methods

(71) Applicant: Jatin Patro, Beaverton, OR (US)

(72) Inventor: Jatin Patro, Beaverton, OR (US)

(21) Appl. No.: 13/371,216

(22) Filed: Feb. 10, 2012

(51) Int. Cl. G06Q 30/00

(52) U.S. Cl. 705/27.1

(57) ABSTRACT

Community-based e-commerce methods for providing a buyer with a set of local retailers affiliated with a selected community and offering a desired type of product. Methods may include storing retailer data including retailer records including retailer affiliation data and retailer location data, receiving into the data storage unit with the central processing unit buyer preference data from the buyer including a desired affiliation and a desired location, selecting with the central processing unit a retailer record from the retailer data, the selected retailer record having retailer affiliation data consistent with the desired retailer affiliation and retailer location data consistent with the desired retailer location, and displaying the selected retailer record. In some embodiments, methods may additionally or alternatively include social networking features.

### BACKGROUND

The present disclosure relates generally to community-based e-commerce methods. In particular, e-commerce methods for providing a buyer with a set of local retailers affiliated with a selected community and offering a desired type of product are described.

Known e-commerce methods are not entirely satisfactory for the range of applications in which they are employed. For example, existing e-commerce methods do not adequately connect buyers with retailers that are affiliated with given communities, including those that have received given accreditations or certifications. Further, existing e-commerce methods do not adequately allow buyers to purchase from retailers products that have received accreditations or certifications.

Known e-commerce methods exist that provide buyers with a list of retailers. Many known methods, however, do not allow buyers purchase products from businesses associated with a selected community. Example communities may include, for example, local trade groups, local chambers of commerce, environmental policy organizations, etc.

Further, many methods that provide buyers with businesses affiliated with these communities do not provide buyers with an elegant means of purchasing from affiliated retailers. Often, communities provide little more than a bare list of affiliated retailers without any purchasing functionality. Thus, there exists a need for e-commerce methods that connect buyers with retailers affiliated with selected communities, particularly those that augment online marketplaces by adding community-based features, such as social networking features.

Known methods' shortcomings are not restricted to the communities listed above. For example, many known methods do not allow buyers to browse retailers based on the certifications and accreditations they have received. For example, buyers may desire to view retailers in a selected area that have received accreditation with the Better Business Bureau. Alternatively, buyers may desire to browse retailers that sell products that have received certifications or accreditations. For example, buyers may desire to view local retailers that offer certified organic products for sale. Thus, there exists a need for e-commerce methods that connect buyers with certified and accredited retailers and products.

Additionally, known e-commerce methods do not adequately connect buyers with retailers that have the capacity to personally deliver products near their locale. Buyers have a particular need for a way to purchase products that may be picked up or delivered locally, as this may reduce shipping costs and time. Even if these are not concerns, buyers often like to support local retailers as a way to drive commerce in their community. Thus, there exists a need for e-commerce methods that connect buyers with local retailers.

Thus, there exists a need for community-based e-commerce methods that improve upon and advance the design of known e-commerce methods. Examples of new and useful methods relevant to the needs existing in the field are discussed below.

### SUMMARY

Community-based e-commerce methods for providing a buyer with a set of local retailers affiliated with a selected community and offering a desired type of product. Methods may include storing retailer data including retailer records including retailer affiliation data and retailer location data, receiving into the data storage unit with the central processing unit buyer preference data from the buyer including a desired affiliation and a desired location, selecting with the central processing unit a retailer record from the retailer data, the selected retailer record having retailer affiliation data consistent with the desired retailer affiliation and retailer location data consistent with the desired retailer location, and displaying the selected retailer record. In some embodiments, methods may additionally or alternatively include social networking features.

### BRIEF DESCRIPTION OF THE DRAWINGS

FIG. 1 is a schematic view of an example of a computer system that may be used to implement the disclosed methods.

FIG. 2 is a flow diagram of a first example of a community-based e-commerce method.

FIG. 3 is a schematic of an example use of the method shown in FIG. 2.

FIG. 4 is a screenshot of an example of a query page that may be used in connection with the method shown in FIG. 2.

FIG. 5 is a screenshot of an example of a product page corresponding to an online storefront used in connection with the method shown in FIG. 2.

### DETAILED DESCRIPTION

The disclosed e-commerce methods will become better understood through review of the following detailed description in conjunction with the figures. The detailed description and figures merely provide examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various e-commerce methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various examples of the disclosed methods may be implemented using electronic circuitry configured to perform one or more functions. For example, with some embodiments of the invention, the disclosed methods may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

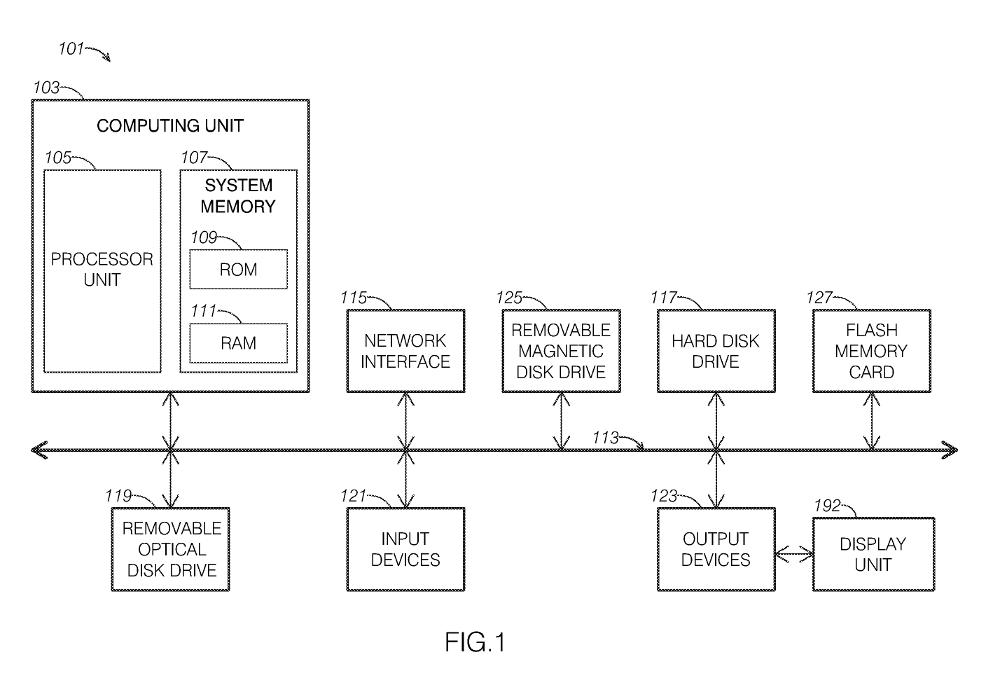

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a display unit, which may include a monitor display, an integrated display, and/or a television, a printer, a stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphones. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone.” As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

With reference to FIGS. 1-5, a first example of a community focused e-commerce method for providing a buyer with a set of local retailers affiliated with a selected community and offering a desired type of product, method 200, will now be described. Method 200 is implemented on computer 101 connected to a computer network via network interface 115. As previously described, computer system includes processor unit 105, shared data storage 107 cooperating with processor unit 105 and storing local retailer data, and a display unit 192 connected to output devices 123.

Many examples of the disclosed inventions discuss displaying data on a display unit. The display unit may include one or more graphical displays, such as computer monitors, televisions, or the like. In some examples of the disclosed methods, the display unit may be connected to computer 101, such as display unit 192 connected to output devices 123. However, in other examples, the display unit may be the display of a client computer connected to computer system 100 via the computer network.

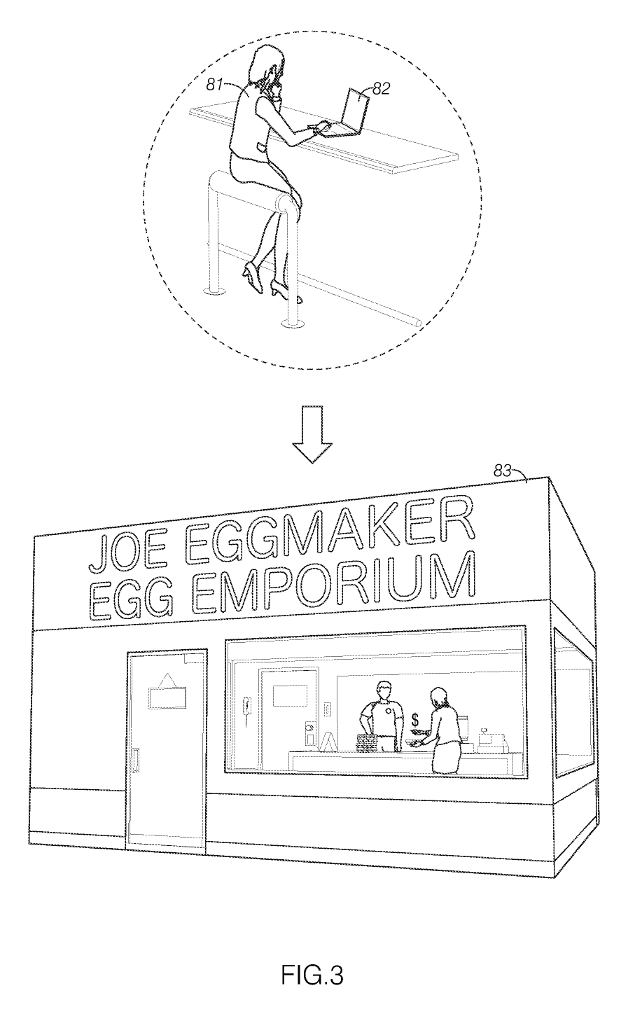

FIG. 3 illustrates a sample case. A buyer 81 may use a computer 82 to set up an appointment to purchase a product from a seller 83 affiliated with a group of sellers and providing local pickup proximate buyer 81. Method 200 allows buyer 81 an easy means of finding local sellers of desired products and/or affiliations, allowing buyer 81 to receive purchased products quickly and in person while forming personal relationships with retailers in his community.

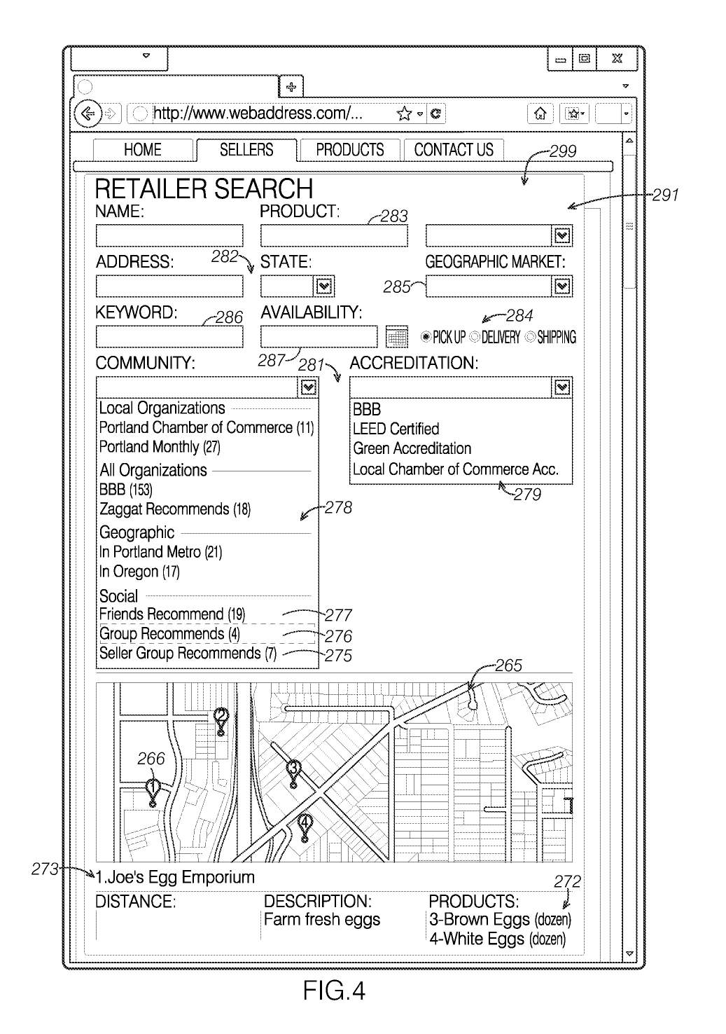

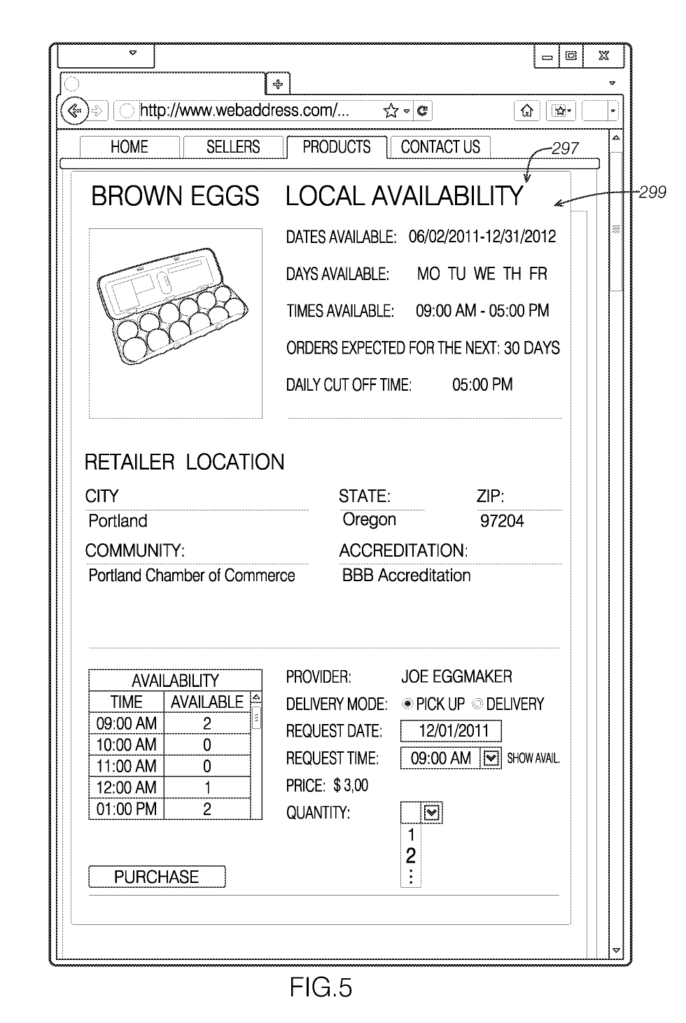

Often, systems implementing method 200 may include a collection of pages defining an online marketplace 299 hosted on computer 101, which may be accessed and viewed through client systems connected via the computer network. FIGS. 4 and 5 illustrate examples of such pages that may be included in online marketplace 299. More precisely, FIG. 4 illustrates a query page 291 where a buyer may search for retailers according to various criteria, and FIG. 5 illustrates an online storefront defining a product page 297 where a buyer may view or purchase an example product from an example retailer.

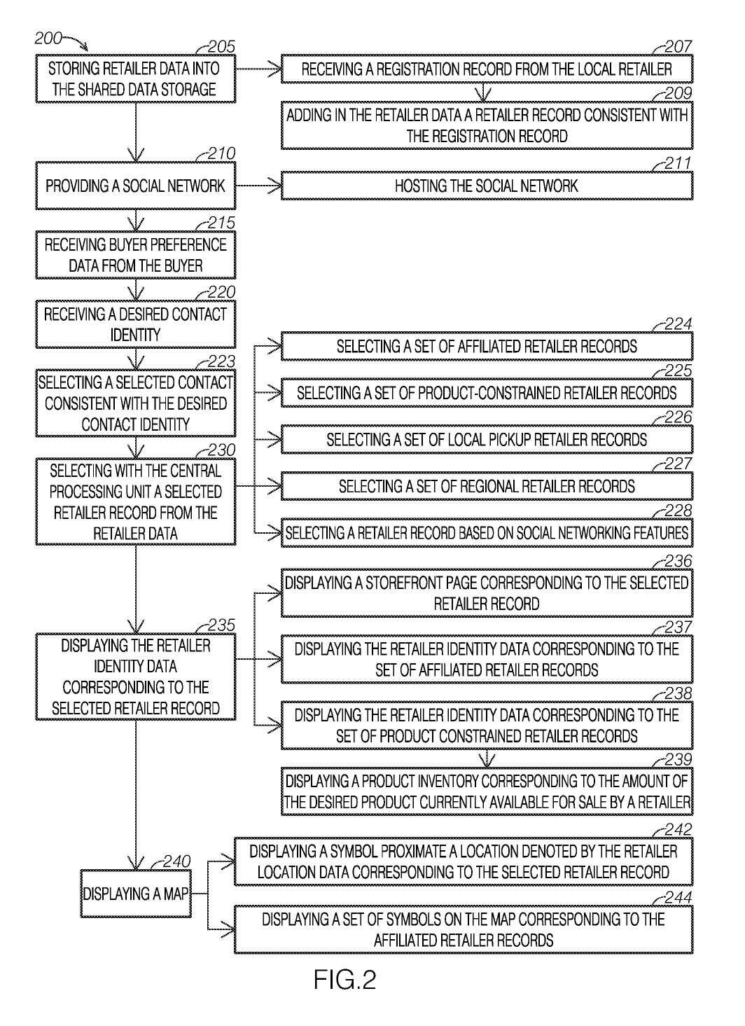

As FIG. 2 illustrates, method 200 includes storing retailer data into the shared data storage at step 205, providing a social network at step 210, receiving buyer preference data from the buyer at step 215, receiving a desired contact identity at step 220, selecting a selected contact consistent with the desired contact identity at step 223, selecting with the central processing unit a selected retailer record from the retailer data at step 230, displaying the retailer identity data corresponding to the selected retailer record at step 235, and displaying a map at step 240.

As FIG. 2 illustrates, retailer data is stored into shared data storage 107 with processor unit 105 at step 205. The retailer data may include a list of retailer records, each of which includes a retailer identity field storing retailer identity data, a retailer location field storing retailer location data, a retailer geographic market field storing retailer geographic market data, a retailer affiliation field storing retailer affiliation data, a retailer product offering field storing retailer product offering data, and a retailer mode of delivery field storing retailer mode of delivery data. Step 205 may additionally include the sub-steps of receiving a registration record from a local retailer at step 207 and adding in the retailer data a retailer record consistent with the registration record at step 209.

The precise user who stores the retailer data or means by which retailer data is stored at step 205 is not material. A system administrator operating computer 101 may manually create a database in certain examples. Local retailers may store the registration data through a client computer connected to computer 101 via a computer network in other examples. In still further examples, non-retailer users, including agents of retailers, reviewers, or certifying authorities, may store the registration data through a client computer connected to computer 101 via a computer network.

The retailer identity data specifies the identity of the retailer identified by the corresponding retailer record. The retailer identity data may include, for example, the business name, trademarks, or service marks. In some examples, the retailer identity data may include a distinct key used by computer 101 to select an individual record.

The retailer location data specifies the geographic location of the corresponding retailer. In some examples, the geographic location may specify a single point or coordinate; in others, it may specify a region or other geographic designation.

The retailer geographic market data specifies the extent of the retailer's geographic market. This information may be used by computer 101 to produce a subset of retailers that are considered local businesses proximate the geographic location. For example, the subset of retailers may operate exclusively in the area around the buyer's current location. Selecting retailers by the scope of their geographic market may assist a buyer in supporting locally owned businesses over larger operations with whom they share no ties.

The retailer affiliation data specifies affiliations of the corresponding retailer. In some examples, these affiliations may identify groups formed amongst retailers. For example, a retailer affiliated with a retailer group may create and store a group of retailers in shared data storage 107 via the computer network and invite other affiliated retailers to join the stored retail group. In some examples, retailers may join a selected stored retail groups through online marketplace 299.

In some examples, the retailer affiliation data may correspond to a retailer certification from a certifying authority. For example, the retailer certification may correspond to accreditation from the Better Business Bureau or LEED certification from the United States Green Building Council awarded to the corresponding retailer's place of business.

In other examples, the retailer affiliation data may include a product certification from a certifying authority awarded to a product offered by the retailer. For example, a retailer may sell USDA organic certified produce.

The retailer affiliation data may additionally or alternatively include a recommendation by a selected recommending organization. In some examples, this recommending organization may simply be a user or group of users using online marketplace 299. In other examples, however, the recommending organization may be an organization that recommends retailers based on criteria such as environmental friendliness, their use of locally sourced products, or the quality of their products, etc.

In these examples, computer 101 may use the retailer affiliation data to provide buyers with a list of retailers affiliated with the selected affiliations. For example, computer 101 may provide a buyer with Better Business Bureau accredited retailers or a list of retailers operating in LEED certified buildings.

The certifying authority may be, in some examples, an official government entity, non-government interest groups, or businesses that regulate an accreditation or certification.

The retailer product offering data lists the products offered by the retailer. In some examples, the retailer product offering data defines a list of all of the products offered by the retailer, allowing buyers to search retailers based on their products. In some examples, the product offering data additionally includes data corresponding to the amount of the desired product currently available for sale by the retailer.

The retailer mode of delivery data relates to the retailer's preference in regard to presenting buyers with purchased products. In some examples, the retailer mode of delivery data may correspond to local pickup, indicating that the seller invites buyers to pick up purchased products at the seller's place of business. In other examples, the retailer mode of delivery data may correspond to local delivery, indicating that the seller is available to personally deliver the product to a local buyer. In further examples, the mode of delivery data may correspond to more conventional online delivery options, such as shipping options.

As FIG. 2 illustrates, a registration record is received from a local retailer at step 207. Often, this registration record is received from a local retailer through a registration page hosted on computer 101 and accessed via the computer network. The registration record may include a retailer identity field, a retailer location field, a retailer geographic market field, a retailer affiliation field, a retailer product offering field, and a retailer mode of delivery field.

As FIG. 2 shows, computer 101 adds a retailer record to the stored retailer data that corresponds to the registration record received at step 209. Computer 101 may then automatically create an online storefront that reflects the submitted registration data, such as online marketplace 299. By automatically creating storefronts for local retailers, the disclosed methods support a diverse online marketplace requiring little manual administration, and may allow retailers to target local buyers online.

As FIG. 2 illustrates, a social network is provided at step 210. In some examples, the social network connects buyers to a list of socially networked contact records. Each socially networked contact record may include a contact identity field storing contact identity data and a contact selected retailer field storing contact selected retailer data corresponding to a retailer record for whom the socially networked contact has provided an opinion. Socially networked contact records may be created, for example, by allowing buyers to register accounts on an online marketplace. In some examples, computer 101 may automatically generate and host profile pages corresponding to the registered buyers. Each of these pages may include a link that allows other registered buyers to connect to them. Computer 101 may additionally or alternatively allow users to manually manage user account settings, wherein they can manage connections.

In some examples, buyers may be connected to sellers. This may be useful, for example, for buyers who would like to find new retailers based on their favorite retailers recommendations.

The contact identity data includes a name that designates the socially networked contact. This may define a username, an alias, the full name of the corresponding buyer, or some other designation. In some examples, the contact identity field could include an automatically generated digital key.

The contact selected retailer data lists retailers that the corresponding contact has singled out for attention by providing an opinion of some kind. This opinion may be any of any form generally supported by online marketplaces. This could include, for example, a review system, a commenting system, a rating system, or a system to tag liked retailers.

In some examples, at least one of the socially networked contacts defines a social network group including a list of group members. The social network group may include group recommended retailer identity data corresponding to local retailers for whom at least one group member provided an opinion. Buyers may want to select retailers based on group recommendations, for example, because groups may provide a more varied selection of retailers than individuals.

In some examples, socially networked contacts, including those that may be members of groups, may provide opinions of the products sold by a retailer rather than the retailer herself. These opinions may be particularly relevant in regard to retailers that make their own goods or perform services.

In some examples, the social network includes a social network seller group including a list of networked seller records. Each networked seller record includes a seller identity field storing retailer identity data. By viewing lists of socially networked sellers, buyers may be able to find retailers based on their relationships to other retailers they liked.

The social network may be hosted at step 211. In some examples, the social network may be hosted on computer 101. In other examples, the disclosed methods may interface with externally hosted social networks, such as Facebook or Google Plus.

As FIG. 2 shows, buyer preference data from the buyer is stored with processor unit 105 receiving into the shared data storage 107 at step 215. In some examples, this buyer preference data is entered into the data storage unit through a search query interface hosted by computer system 100. Buyers may access the search query interface via a client, such as a web browser being operated on a client terminal computer connected to computer 101 via the computer network. FIG. 4 illustrates an example of such a search query interface, query page 291, displayed on a client display.

As FIG. 4 illustrates, a buyer may enter buyer preference data into entries on query page 291. This buyer preference data may include, for example, a desired retailer affiliation entered into a community entry 281, a desired retailer location entered into a location entry 282, a desired product entered into a product entry 283, and a desired retailer mode of delivery entered into a delivery entry 284. After the buyer submits the query, the entered buyer preferences are stored in memory and may be accessed and used to determine local retailers consistent with the buyer's preferences.

The buyer preference data may include a desired retailer affiliation. The desired retailer affiliation may be entered, for example, in community entry 281. The entered data may correspond to a community entered in a community selection 278 or an accreditation or certification selection in accreditation selection 279.

In various examples, the desired retailer affiliation may include a retailer certification from a certifying authority, a product certification from a certifying authority, or a recommendation by a selected recommending organization. These desired retailer affiliations often include data consistent with the corresponding types of retailer affiliation data discussed above.

In some examples, community entry 281 may be automatically generated based on retailer affiliation data of previously stored retailer records. For example, an automatically generated dropdown list including a Better Business Bureau listing may automatically appear on a query page generated for an online marketplace with retailer records corresponding to Better Business Bureau accredited businesses.

The desired retailer location may correspond to a geographic location selected by the user. The selected geographic location may correspond to a specific point in some examples; it may correspond to an area or region in others. The geographic location may additionally or alternatively correspond to a selected town, city, metropolitan area, or other officially designated region. In some examples, the desired retailer location is determined automatically in response to an internet address of the buyer, such as her internet protocol address.

The buyer preference data may also include a desired geographic market entered in a geographic market entry 285. The desired geographic market may, but is not required to, correspond to an area proximate the desired retailer location. Buyers may select a desired geographic market to assist in finding retailers that are local and specific to selected communities.

The buyer preference data may additionally or alternatively include a desired product selected by a buyer. The name of the desired product, in some examples, may be entered into a text entry, such as product entry 283. Additionally or alternatively, products, classes of products, or other product identifiers may be entered in keyword entry 286. In yet other examples, the desired product could be selected from a list of products offered by retailers in the online marketplace, which could be generated automatically by computer system 100.

The buyer preference data may include a desired retailer mode of delivery. In some examples, the desired retailer mode of delivery may be entered in delivery entry 284. In some examples, buyers may choose more than one desired mode of delivery. In other examples, buyers and sellers may determine a chosen method of delivery in a future communication.

Some examples may further allow buyers to search retailers based on their hours or availability in availability entry 287.

The buyer preference data may additionally or alternatively include a desired contact identity, received at step 220. The desired contact identity corresponds to a socially networked contact provided at step 210 and connected to the buyer. A buyer may choose a desired contact identity, for example, by selecting a friend 277 in community entry 278.

As FIG. 2 illustrates, a selected contact record with contact identity data consistent with the desired contact identity is selected from the list of socially networked contact records at step 223. The selected contact record may be used to correlate the contact desired by the buyer with retailers that the contact has provided an opinion for or recommended.

The buyer preference data may additionally or alternatively include a desired social network seller group, the social network seller group corresponding to a seller group provided at step 210. A buyer may choose a desired social network seller group by selecting a group 276 in community selection 278.

As FIG. 2 illustrates, a retailer record from the retailer data is selected with the central processing unit at step 230. In some cases, multiple retailer records may be selected. Selecting retailer records may involve selecting records from the retailer data that have retailer affiliation data consistent with a buyer's desired retailer affiliation and retailer location data consistent with a buyer's desired retailer location. In some examples, step 230 includes selecting a set of affiliated retailer records at step 224, selecting a retailer record from the retailer data may further include selecting a set of product-constrained retailer records at step 225, selecting a set of local pickup retailer records at step 226, selecting a set of regional retailer records at step 227, selecting with the central processing unit a retailer record based on social networking features at step 228. Upon selecting the selected retailer records, computer system 100 may use the selected records to, for example, display the data stored in the selected retailer record's data fields, generate product pages and storefronts corresponding to the selected record, or otherwise electronically display or manipulate the selected records.

In step 230, its substeps, or any of the substeps or similar disclosed “selection” steps, relevant retailer data need not be identical to the corresponding buyer preference data to be “consistent.” Indeed, the buyer preference data may include an abstract or inexact representation of the buyer's preferences. In some instances, for example, consistency between retailer data and buyer preference data arise from a synonym, genus, class, or keyword similar to the retailer data. Additionally or alternatively, a consistency algorithm may be used to deem retailer data consistent when the algorithm generates a threshold confidence value based on the buyer preference data and the retailer data. In certain examples, the buyer preference data may only include a portion of the corresponding retailer data field, or vice versa. Additionally, some examples may find consistency despite misspellings, in an effort to reduce user error.

As FIG. 2 shows, a set of affiliated retailer records having retailer affiliation data consistent with the desired retailer affiliation is selected at step 224. By selecting a set of affiliated retailer records instead of an individual retailer record, computer 101 may provide a buyer with a better sense of the number and identity of local retailers affiliated with the desired affiliation than an individual record would provide. The disclosed methods may similarly provide sets of records based on other reference criteria.

As FIG. 2 shows, a set of product-constrained retailer records is selected at step 225. The product-constrained retailer records each have product offering data consistent with the desired product selected by a buyer at step 215, allowing buyers to quickly identify retailers carrying goods for which they are searching.

In some examples, the product-constrained retailers offer a list of products including the desired product. In other examples, however, the product-constrained retailers may exclusively sell the desired product. The buyer may, in some cases, enter a preference as to whether the product-constrained retailers are selected according to either of these methods.

In other examples, the product-constrained retailers may be further constrained by the amount of the desired product currently available for sale. In some cases, only retailers with available stock will be listed. In other examples, retailers may be listed even if they are out of stock of the desired product, or even if they have discontinued selling the desired product. This is useful in the case of seasonal products or other types of products that are sporadically available.

As FIG. 2 shows, a set of local pickup retailer records is selected from the retailer data with the central processing unit at step 226. The set of local pickup retailer records each include mode of delivery data requesting local pickup. By selecting the local pickup records, a buyer is able to easily find sellers that have products immediately available to pick up locally. Selecting local pickup records may provide buyers with a quick way to purchase products online and support local commerce, especially when compared to shipping-based online retailers.

In other examples, a set of local delivery retailer records may be similarly selected, the local delivery records including mode of delivery data. Mode of delivery data may include the retailer delivering the goods to a buyer in a local region herself or shipping the goods to a non-local region via a carrier. Retailers providing local delivery may include retailers that employ drivers to personally distribute their products within a geographic region. Selecting local delivery retailer records may provide buyers with a quick way to purchase products online, especially when compared to shipping-based online retailers.

As FIG. 2 illustrates, a set of regional retailer records is selected from the retailer data with the central processing unit at step 227. The regional retailer records may include geographic market data consistent with a desired geographic market entered by the buyer in geographic market entry 285. In some examples, the set of regional retailer records may include only retailers that operate exclusively in a geographic region proximate a desired location. The desired location region may define a town, city, metropolitan area, state, country, or any other geographic designation. This may provide a list of local retailers that is tailored to locally owned and operated businesses by eliminating businesses that operate in other regions or areas.

As FIG. 2 shows, a retailer record based on social networking features may be selected at step 228. For example, a retailer record with retailer identity data consistent with the retailer identity data of the selected contact record entered in community selection 278 may be selected. The selected retailer record corresponds to a retailer for whom the contact has provided an opinion of or recommended.

In additional or alternative examples, the selected retailer record may include retailer identity data consistent with the group recommended retailer identity data. The selected retailer record corresponds to a retailer for whom a member of a buyer selected group has provided an opinion or recommendation.

In other examples, the selected retailer record may have retailer identity data consistent with the retailer identity data of a networked retailer record in the desired social network group. The networked retailer record may be consistent with a desired seller group 275 entered in community selection 278.

As FIG. 2 illustrates, the retailer identity data corresponding to the selected retailer record is displayed on display unit with the central processing unit at step 235. Step 235 may additionally include displaying a storefront page corresponding to the selected retailer record at step 236, displaying the retailer identity data corresponding to the set of affiliated retailer records at step 237, and displaying the retailer identity data corresponding to the set of product-constrained retailer records at step 238.

In some examples, the selected retailer record that is displayed may have been selected using social networking criteria. For example, in some examples, the displayed retailer records may correspond to retailers recommended by a socially networked contact, group, or seller group.

As FIG. 2 shows, a storefront page corresponding to the selected retailer record selected at step 223 is displayed on the display unit with the central processing unit at step 236. This storefront page may display retailer data corresponding to the selected retailer, such as the selected retailer's hours/availability, the selected retailer's offered products, the selected retailer's mode of delivery data, the selected retailer's affiliations, or the selected retailer's location, etc. In some examples, this storefront page may provide an option for purchasing products from the selected retailer or setting appointments with the selected retailer. In some examples, the storefront may define a product page, such as product page 297 shown in FIG. 5. Product pages, or other online marketplace pages, may in some examples include a display of the geographic location of the retailer, one or more communities to which the retailer belongs, one or more accreditations that the retailer has received, the quantities of products available, scheduling data displaying when the retailer is available to sell the displayed available quantities, and other details relating to the retailer or product. FIG. 5 illustrates product page 297 displaying many of these features. Although FIG. 5 displays a record belonging to a single community and receiving a single accreditation, the disclosed methods equally accommodate retailers and products that are members of multiple communities and retailers that have received multiple accreditations.

As FIG. 2 illustrates, the retailer identity data corresponding to each retailer record in the set of affiliated retailer records selected at step 224 is displayed on the display unit with the central processing unit at step 237. Displaying the set of affiliated retailer records allows buyers to browse a listing of multiple affiliated retailer records, giving the buyer a fuller picture of the affiliated retailer records proximate the desired location than the display of an individual record would provide. FIG. 4 displays an example of such a listing, listing 273.

As FIG. 2 shows, the retailer identity data corresponding to each record of the set of product-constrained retailer records selected at step 225 is displayed on the display unit with the central processing unit at step 238. In some examples, the retailer identity data corresponding to the set of product-constrained retailer records at step 238 additionally includes displaying on the display unit with the central processing unit a product inventory corresponding to the amount of the desired product currently available for sale by a retailer at step 239. FIG. 4 displays an example of such an inventory, inventory 272. Displaying the set of product-constrained retailer records allows buyers to browse a listing of multiple retailers and the products they provide. This allows buyers to get a clear picture of the local retailers that sell their desired product.

The displayed inventory may, in some examples, hyperlink to a product page, similar to product page 297. In some examples, the displayed inventory may reflect the total number of products available for sale by a retailer. These products may be, but are not required to be, similar in type. In some examples, the inventory may hyperlink to a page displaying a collection of individual products available from the retailer.

As FIG. 2 shows, a product inventory corresponding to the amount of the desired product currently available for sale by is displayed on the display unit with the central processing unit at step 239. In some examples, multiple product inventories may be displayed next to multiple retailers selected from the set of product-constrained retailer records. In some circumstances, the product inventory will only be displayed if it is equal or greater than an amount selected by either the buyer or the retailer. By displaying the inventory, buyers are able to easily browse local retailers that currently have a sufficient quantity of their desired product available for sale.

In some examples, displaying on the display unit with the central processing unit the retailer identity data corresponding to the contact recommended retailer record includes displaying a rating proximate the display of the retailer identity data, the rating corresponding to users' opinions of a product offered for sale by the retailer. This provides buyers with a display of the product that is delineated from reviews, ratings, or recommendations of the retailer herself. Often, the reviews will be provided via the social network groups, contacts, and seller contacts provided at step 210.

As FIG. 2 shows, a map is displayed on the display unit with the central processing unit at step 240. In some examples, displaying the map at step 240 may include displaying a symbol proximate a location denoted by the retailer location data corresponding to the selected retailer record at step 242 and displaying a set of symbols on the map corresponding to the affiliated retailer records at step 244. In some examples, the displayed map shows a graphical depiction of a displayed region proximate the desired location. FIG. 4 displays an example of such a map, map 265.

Displayed maps may often additionally or alternatively include symbols depicting transportation throughways in the displayed region. The displayed region may additionally or alternatively be adjusted via manipulating the map. In some examples, adjusting the displayed region may adjust the desired location. In such examples, buyers may adjust the displayed region to target retailers that provide local delivery to or local pickup near a desired location.

As FIG. 2 illustrates, a symbol is displayed proximate a location denoted by the retailer location data corresponding to the selected retailer record at step 242. FIG. 4 illustrates an example of such a symbol, symbol 266. This symbol may, in some examples, additionally include text, manipulable features, or links that may provide additional functionality to the displayed symbol. For example, the symbol may display a retailer's available products or the inventory associated with a retailer's available product.

In some examples, a set of symbols may be displayed on the map, such as at step 244. In such examples, each symbol of the set of symbols may be displayed at a location on the map proximate a location denoted by the retailer location data of a corresponding retailer record. The retailer record may further correspond to a retailer record selected in the set of affiliated retailer records selected at step 224

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A community-based e-commerce method for providing a buyer with a set of local retailers affiliated with a selected community and offering a desired type of product, the method implemented on a display unit and a computer system connected to a computer network, the computer system including a central processing unit, and a shared data storage cooperating with the central processing unit and storing local retailer data, the method comprising:
storing retailer data into the data storage unit with the central processing unit, the retailer data including a list of retailer records, each retailer record including a retailer identity field storing retailer identity data, a retailer location field storing retailer location data and a retailer affiliation field storing retailer affiliation data;
receiving into the data storage unit with the central processing unit buyer preference data from the buyer, the buyer preference data including a desired retailer affiliation and a desired retailer location;
selecting with the central processing unit a selected retailer record from the retailer data, the selected retailer record having retailer affiliation data consistent with the desired retailer affiliation and retailer location data consistent with the desired retailer location; and
displaying on the display unit with the central processing unit the retailer identity data corresponding to the selected retailer record.

2. The method of claim 1, wherein storing retailer data into the data storage unit with the central processing unit further comprises:
receiving a registration record from a local retailer via the computer network, the registration record including a registration identity field storing retailer identity data, a registration location field storing retailer location data, and a registration affiliation field storing retailer affiliation data; and
adding the registration record in the retailer data.

3. The method of claim 1, wherein displaying on the display unit with the central processing unit the retailer identity data corresponding to the selected retailer record includes displaying on the display unit with the central processing unit a storefront page corresponding to the selected retailer record.

4. The method of claim 1, further comprising displaying on the display unit a map with the central processing unit, displaying the map including displaying a symbol at a location on the map proximate a location denoted by the retailer location data corresponding to the selected retailer record.

5. The method of claim 1, wherein selecting with the central processing unit a retailer record from the retailer data includes selecting with the central processing unit a set of affiliated retailer records from the retailer data having retailer affiliation data consistent with the desired retailer affiliation;
wherein displaying on the display unit the retailer identity data includes displaying on the display unit with the central processing unit the retailer identity data corresponding to each retailer record in the set of affiliated retailer records.

6. The method of claim 5, further comprising displaying on the display unit a map with the central processing unit, displaying the map including displaying a set of symbols on the map, each symbol in the set of symbols displayed at a location on the map proximate a location denoted by the retailer location data of a corresponding affiliated retailer record.

7. The method of claim 1, wherein:
each retailer record stored into the data storage unit with the central processing unit includes a retailer product offering field storing retailer product offering data;
the buyer preference data includes a desired product;
selecting with the central processing unit a retailer record from the retailer data includes selecting a set of product-constrained retailer records with product offering data consistent with the desired product; and
displaying on the display unit the retailer identity data includes displaying on the display unit with the central processing unit the retailer identity data of each record of the set of product-constrained retailer records.

8. The method of claim 7, wherein displaying on the display unit with the central processing unit the retailer identity data of each record of the set of product-constrained retailer records includes displaying on the display unit with the central processing unit a product inventory corresponding to the amount of the desired product currently available for sale by a selected retailer selected from the retailers in the set of product-constrained retailer records.

9. The method of claim 1, wherein:
each retailer record stored into the data storage unit with the central processing unit includes a retailer mode of delivery field storing mode of delivery data, the mode of delivery data representing the retailer's delivery options including the retailer's willingness to allow buyers to pick up the product from the retailer;
the buyer preference data includes a desired mode of delivery, the desired mode of delivery including picking up the product from the retailer; and
selecting with the central processing unit a retailer record from the retailer data includes selecting a set of local pickup retailer records with mode of delivery data consistent with the desired mode of delivery.

10. The method of claim 1, wherein:
each retailer record stored into the data storage unit with the central processing unit includes a retailer mode of delivery field storing mode of delivery data, the mode of delivery data representing the retailer's delivery options including the retailer's willingness to personally deliver products to local buyers;
the buyer preference data includes a desired mode of delivery, the desired mode of delivery including receiving delivery of the product from the retailer, and
selecting with the central processing unit a retailer record from the retailer data includes selecting a set of local delivery retailer records with mode of delivery data consistent with the desired mode of delivery.

11. The method of claim 1, wherein:
each retailer record stored into the data storage unit with the central processing unit includes a retailer geographic market field storing geographic market data representing the extent of the retailer's geographic market; and
selecting with the central processing unit a retailer record from the retailer data includes selecting a set of regional retailer records with geographic market data limited to a geographic region proximate the desired location.

12. The method of claim 1, wherein the desired affiliation includes a retailer certification from a certifying authority.

13. The method of claim 1, wherein the desired affiliation includes a product certification from a certifying authority.

14. The method of claim 1, wherein the desired affiliation includes a recommendation by a selected recommending organization.

15. The method of claim 1, further comprising providing a social network connecting the buyer to a list of socially networked contact records, wherein each socially networked contact record includes a contact identity field storing contact identity data and a contact selected retailer field storing contact selected retailer data corresponding to a retailer record for whom the socially networked contact has provided an opinion;
wherein the buyer preference data from the buyer including a desired socially networked contact corresponding to a socially networked contact record;
further comprising:
selecting from the list of socially networked contact records a selected contact record with contact identity data consistent with the desired contact identity;
selecting a selected retailer record from the retailer data having retailer identity data consistent with the contact recommended retailer identity data of the selected contact record; and
displaying on the display unit with the central processing unit the retailer identity data corresponding to the selected retailer record.

16. A community-based e-commerce method for providing buyers a set of local retailers based on recommendations received through a social network, the method implemented on a display unit and a computer system connected to a computer network, the computer system including a central processing unit and a shared data storage cooperating with the central processing unit, the method comprising:
storing retailer data into the data storage unit with the central processing unit, the retailer data including a list of retailer records, each retailer record including a retailer identity field storing retailer identity data;
providing a social network connecting the buyer to a list of socially networked contact records, wherein each socially networked contact record includes a contact identity field storing contact identity data and a contact selected retailer field storing contact selected retailer data corresponding to a retailer record for whom the socially networked contact has provided an opinion;
receiving into the data storage unit buyer preference data from the buyer including a desired socially networked contact corresponding to a socially networked contact record;
selecting from the list of socially networked contact records a selected contact record with contact identity data consistent with the desired contact identity;
selecting a selected retailer record from the retailer data having retailer identity data consistent with the contact recommended retailer identity data of the selected contact record; and
displaying on the display unit with the central processing unit the retailer identity data corresponding to the selected retailer record.

17. The met hod of claim 0, wherein:
at least one of the socially networked contacts defines a social network group including a list of group members and a group recommended retailer identity data corresponding to local retailers for whom at least one group member provided an opinion; and
the selected retailer record includes retailer identity data consistent with the group recommended retailer identity data.

18. The method of claim 17, wherein displaying on the display unit with the central processing unit the retailer identity data corresponding to the contact recommended retailer record includes displaying a rating proximate the display of the retailer identity data, the rating corresponding to the social network group's collective opinion of a product offered for sale by the retailer.

19. The method of claim 0, further comprising hosting the social network on the computer system.

20. A community-based e-commerce method for providing buyers a set of local retailers based on recommendations received through a social network, the method implemented on a display unit and a computer system connected to a computer network, the computer system including a central processing unit and a shared data storage cooperating with the central processing unit, the method comprising:
storing retailer data into the data storage unit with the central processing unit, the retailer data including a list of retailer records, each retailer record including a retailer identity field storing retailer identity data;
providing a social network including a social network group including a list of networked seller records, wherein each networked seller record includes a seller identity field storing retailer identity data;
receiving into the data storage unit buyer preference data from the buyer including a desired social network group;
selecting a selected retailer record from the retailer data having retailer identity data consistent with the retailer identity data of a networked seller record in the desired social network group; and
displaying on the display unit with the central processing unit the retailer identity data corresponding to the selected retailer record.
